(19) United States
(12) Patent Application Publication
(10) Pub. No.: US 2012/0144293 A1
(43) Pub. Date: Jun. 7, 2012

(54) DISPLAY APPARATUS AND METHOD OF PROVIDING USER INTERFACE THEREOF

(75) Inventor: Min-soo KIM, Gwangmyeong-si (KR)

(73) Assignee: Samsung Electronics Co., Ltd., Suwon-si (KR)

(21) Appl. No.: 13/242,896

(22) Filed: Sep. 23, 2011

(30) Foreign Application Priority Data
Dec. 6, 2010 (KR) 2010-0123500

(51) Int. Cl. G06F 17/00

(52) U.S. Cl. 715/255

(57) ABSTRACT

A display apparatus is provided and includes a display unit displaying a data object in the form of a corresponding icon, a user interface unit receiving a preset touch operation corresponding to an editing function of the data object, an editing unit to perform editing of the data object, and a control unit operating to perform the editing of the data object that corresponds to the preset touch operation when the preset touch operation for the icon is performed in an editing mode. Accordingly, a user's convenience can be sought.

### CROSS-REFERENCE TO RELATED APPLICATIONS

This application claims the benefit of priority under 35 U.S.C. §119(a) to Korean Patent Application No. 10-2010-0123500, filed on Dec. 6, 2010, in the Korean Intellectual Property Office, the disclosure of which is incorporated herein by reference in its entirety.

### BACKGROUND OF THE INVENTION

1. Field of the Invention

The present general inventive concept relates to a display apparatus and a method of providing a user interface (UI) thereof, and more particularly, to a display apparatus and a method of providing a UI thereof which can provide an editing function of a data object

2. Description of the Related Art

Functions that are frequently used when an image is edited in the related art may include “file merge”, “file divide”, “partial cut”, and the like. For example, when an edit function is independently performed in a mobile appliance without a personal computer (PC), the following steps are generally performed in a thumbnail view state.

First, in the case of the “file merge”, processes are performed in the order of \textcircled{1} menu selection→\textcircled{2} merge function selection→\textcircled{3} selection of files to be merged→\textcircled{4} merge performance.

In the case of the “file divide”, processes are performed in the order of \textcircled{1} menu selection→\textcircled{2} divide function selection→\textcircled{3} selection of a file to be divided→\textcircled{4} selection of divide points→\textcircled{5} divide performance (the order of processes \textcircled{1} and \textcircled{3} may be changed depending on the appliance).

Also, in the case of the “partial cut”, processes are performed in the order of \textcircled{1} menu selection→\textcircled{2} partial cut function selection→\textcircled{3} selection of a file to be cut→\textcircled{4} selection of two cut points→\textcircled{5} partial cut performance (the order of processes \textcircled{1} and \textcircled{3} may be changed depending on the appliance).

Also, in the case of touching a touch panel in a thumbnail state in a mobile appliance using the touch panel, selection, viewing, and movement of a corresponding file can be performed, and using dragging distances between two fingers, image enlargement and reduction can be performed. Also, icons for copy, partial cut, paste, and the like, can be constantly positioned on a screen.

However, although touch panels have been spread in mobile appliances, many menu operations based on the existing five direction keys (up, down, left, right, and center) are still used, and thus it is required to pass through several menu steps when a specified function is performed. Also, when several files are selected, even in the case of successive data, it is required to select respective files by touching the respective files (in the case of a PC, mouse drag is frequently used).

Also, due to the limit of a screen size on the characteristics of a mobile appliance, it is difficult to display several windows on the screen, and thus implementation of a paste function after performing a partial cut operation becomes difficult (i.e., it is difficult to confirm the existence/nonexistence of the cut data and to perform the paste of the cut file to another file that is different from the cut file, and area deletion is frequently used ←→ in the case of a window-based PC, it can be simply performed by Ctrl+C or cut Ctrl+V).

On the other hand, since the editing function icon is constantly positioned on the screen, an actually usable screen becomes narrow.

### SUMMARY OF THE INVENTION

The present general inventive concept addresses at least the above problems and/or disadvantages and provides at least the advantages described below. Accordingly, an aspect of the present general inventive concept provides a display apparatus and a method of providing a user interface (UI) thereof, which can provide an intuitive UI for performing a data editing function.

Additional aspects and utilities of the present general inventive concept will be set forth in part in the description which follows and, in part, will be obvious from the description, or may be learned by practice of the general inventive concept.

The foregoing and/or other features and utilities of the present general inventive concept may be realized by a display apparatus, which includes a display unit to display a data object in the form of a corresponding icon, a user interface unit to receive a preset touch operation corresponding to an editing function to edit the data object, an editing unit to perform the editing function to edit the data object, and a control unit operating to control the editing unit to perform the editing function to edit the data object that corresponds to the preset touch operation when the preset touch operation for the icon is performed in an editing mode.

Here, the editing function may include at least one of a data object merge function, a data object division function, and a clip board function.

In this case, the preset touch operation that corresponds to the data object division function may be an operation of selecting and touching at least two points of the data object, widening a space between the at least two selected points, and then releasing the touch if it is intended to divide the data object.

The control unit may operate to convert the editing mode into a reproduction mode to separate a moving image in accordance with the preset touch operation that corresponds to the data object division function in the case where the data object is a moving image.

The display unit may display at least two data objects and the preset touch operation that corresponds to the data object merge function may be an operation of simultaneously touching two data objects, narrowing a space between the two data objects, and then releasing the touch if it is intended to select and merge the two data objects.

Also, the display unit may display at least three data objects and the preset touch operation that corresponds to the data object merge function may be an operation of touching a first data object, successively selecting and dragging areas in which icons that correspond to at least two other data objects to be merged are displayed to the first data object, and then releasing the touch of the first data object if it is intended to select and merge the at least three data objects.

The control unit may operate to create a clip board area of the data object in a predetermined area of a screen of the display unit and to display the data object in the form of an icon on the created area in accordance with the preset touch operation to perform the clip board function.

The clip board area may include at least one of a copy area and a deletion area, and the control unit may operate to copy or delete the data object by selecting and dragging the data object to the copy area or the deletion area, respectively.

The control unit may operate to perform a paste function of the data object by touching and dragging the data object copied onto the copy area to a desired position.

The control unit may operate to perform a partial cut function of the data object by selecting an area to be cut from the data object and dragging the selected area to the deletion area.

The foregoing and/or other features and utilities of the present general inventive concept may also be realized by a method of providing a UI of a display apparatus, which includes displaying a data object in the form of an icon, receiving a preset touch operation corresponding to an editing function to edit the data object, and performing the editing function that corresponds to the preset touch operation when the preset touch operation for the icon is performed in an editing mode.

Here, the editing function may include at least one of a data object merge function, a data object division function, and a clip board function.

In this case, the preset touch operation that corresponds to the data object division function may be an operation of selecting and touching at least two points of the data object, widening a space between the at least two selected points, and then releasing the touch if it is intended to divide the data object.

The method of providing the UI may further include converting the editing mode into a reproduction mode to separate a moving image in accordance with the preset touch operation that corresponds to the data object division function in the case where the data object is a moving image.

Also, the displaying the data object may further include displaying at least three data objects and the preset touch operation that corresponds to the data object merge function may be an operation of touching a first data object, successively selecting and dragging areas, in which icons that correspond to at least two other data objects to be merged are displayed to the first data object, and then releasing the touch of the first data object if it is intended to select and merge the at least three data objects.

Also, the displaying the data object may further include displaying at least two data objects and the preset touch operation that corresponds to the data object merge function is an operation of simultaneously touching two data objects, narrowing a space between the two data objects, and then releasing the touch if it is intended to select and merge the two data objects.

The method of providing the UI may further include creating a clip board area of the data object in a predetermined area of a screen of the display unit and displaying the data object in the form of an icon on the created area in accordance with the preset touch operation to perform the clip board function.

The clip board area may include at least one of a copy area and a deletion area, and the method of providing the UI may further include copying or deleting the data object by selecting and dragging the data object to the copy area or the deletion area, respectively.

The method of providing the UI may further include performing a paste function of the data object by touching and dragging the data object copied onto the copy area to a desired position.

The method of providing the UI may further include performing a partial cut function of the data object by selecting an area to be cut from the data object and dragging the selected area to the deletion area.

The foregoing and/or other features and utilities of the present general inventive concept may also be realized by a display apparatus including a display unit to display at least one data object in the form of a corresponding icon, a user interface unit to receive a plurality of preset touch operations corresponding to respective editing functions to edit the data object, wherein at least one of the plurality of touch operations comprises touching at least two points on the display unit simultaneously, a control unit to determine which one of the plurality of preset touch operations is received by the user interface unit, and an editing unit to perform the respective editing function corresponding to the determined preset touch operation.

The plurality of preset touch operations may include at least one of a preset touch operation corresponding to a data object merge function, a preset touch operation corresponding to a data object division function, and a preset touch operation corresponding to a copy function.

The at least one data object may include a first data object and a second data object and the preset touch operation corresponding to the data object merge function may include touching the first data object and the second data object simultaneously, sliding the first data object and the second data object into each other, and then releasing the touches on the first data object and the second data object.

The at least one data object may include a plurality of data objects and the preset touch operation corresponding to the data object merge function may include touching a first data object of the plurality of data objects, and while touching the first data object, successively touching, sliding into the first data object, and releasing the touch on each of the plurality of data objects to be merged with the first data object, and then releasing the touch on the first data object.

The preset touch operation corresponding to the data object division function may include simultaneously touching two points of one of the at least one data object, sliding the two touched points away from each other, and then releasing the touch.

The display unit may display the data corresponding to one of the at least one data object and the preset touch operation corresponding to the copy function may include simultaneously touching two points within the data and releasing the touches on the two points to select an area of the data, and then touching the selected area of the data, sliding the selected area of the data to a predetermined copy area, and releasing the touch on the selected area.

The foregoing and/or other features and utilities of the present general inventive concept may also be realized by a method of providing a UI of a display apparatus including displaying at least one data object in the form of a corresponding icon, receiving one of a plurality of preset touch operations corresponding to respective editing functions to edit the data object, wherein at least one of the plurality of preset touch operations comprises touching at least two points on the display unit simultaneously, determining which one of the plurality of preset touch operations is received, and performing the respective editing function corresponding to the determined preset touch operation.

The plurality of preset touch operations may include at least one of a preset touch operation corresponding to a data object merge function, a preset touch operation corresponding to a data object division function, and a preset touch operation corresponding to a copy function.

The at least one data object may include a first data object and a second data object and the preset touch operation corresponding to the data object merge function may include touching the first data object and the second data object simultaneously, sliding the first data object and the second data object into each other, and then releasing the touches on the first data object and the second data object.

The at least one data object may include a plurality of data objects and the preset touch operation corresponding to the data object merge function may include touching a first data object of the plurality of data objects, and while touching the first data object, successively touching, sliding into the first data object, and releasing the touch on each of the plurality of data objects to be merged with the first data object, and then releasing the touch on the first data object.

The preset touch operation corresponding to the data object division function may include simultaneously touching two points of one of the at least one data object, sliding the two touched points away from each other, and then releasing the touch.

The displaying may include displaying the data corresponding to one of the at least one data object and the preset touch operation corresponding to the copy function may include simultaneously touching two points within the data and releasing the touches on the two points to select an area of the data, and then touching the selected area of the data, sliding the selected area of the data to a predetermined copy area, and releasing the touch on the selected area.

The foregoing and/or other features and utilities of the present general inventive concept may also be realized by a display apparatus including a display unit to display one or more data objects, and a control unit to select one of the displayed data objects and to separate the selected data object into at least two data objects that each include a portion of the selected data object according to a first touch operation on the selected data object, and to select at least two of the displayed data objects and to merge the at least two selected data objects into one data object according to a second touch operation on the at least two selected data objects.

Accordingly, the data editing process is shortened, and an efficient editing can be performed.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating the configuration of a display apparatus according to an exemplary embodiment of the present general inventive concept;

FIGS. 2A to 2D are diagrams illustrating a method of providing a UI for a data object merge function according to an exemplary embodiment of the present general inventive concept;

FIGS. 3A to 3D are diagrams illustrating a method of providing a UI for a data object division function according to an exemplary embodiment of the present general inventive concept;

FIGS. 4A to 4E are diagrams illustrating a method of providing a UI for a data object clip board function according to an exemplary embodiment of the present general inventive concept;

FIGS. 5A to 5F are diagrams illustrating a method of providing a UI for a data object clip board function according to another exemplary embodiment of the present general inventive concept;

FIGS. 6A and 6B are diagrams illustrating a method of providing a UI for a data object clip board function according to still another exemplary embodiment of the present general inventive concept;

FIG. 7 is a diagram illustrating a method of displaying an area for a clip board function according to an exemplary embodiment of the present general inventive concept; and

FIG. 8 is a flowchart illustrating a method of providing a UI according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. However, the present disclosure is not restricted or limited to such embodiments. In explaining the present disclosure, well-known functions or constructions will not be described in detail so as to avoid obscuring the description with unnecessary detail.

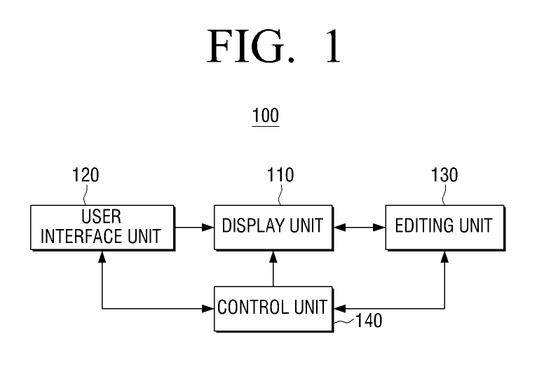

FIG. 1 is a block diagram illustrating the configuration of a display apparatus according to an exemplary embodiment of the present general inventive concept.

Referring to FIG. 1, a display apparatus 100 according to an exemplary embodiment of the present general inventive concept includes a display unit 110, a user interface unit 120, an editing unit 130, and a control unit 140.

The display apparatus 100 may be implemented in various forms. For example, the display apparatus 100 may be implemented by a mobile terminal, such as a portable phone, a smart phone, a notebook computer, a terminal for digital broadcasting, a PDA (Personal Digital Assistants), a PMP (Portable Multimedia Player), a navigation device, and the like, and a terminal, such as a digital YV, a desktop computer, and the like. Hereinafter, however, for convenience in explanation, it is assumed that the display apparatus 100 is a mobile terminal. However, it can be easily understood by those of ordinary skill in the art that the configuration to be described hereinafter can be applied to a fixed terminal except for the configuration elements specially configured for mobility.

The display unit 110 may display various data objects in the form of icons. Here, the data objects may be in various data forms, such as moving images, images, texts, applications, sound data, photo slide shows, and the like. Also, the icons may be displayed in diverse forms including thumbnail forms of respective data objects.

Specifically, the display unit 110 may be implemented in a touch screen form that forms a mutual layer structure with a touch pad. In this case, the display unit 110 may be used as a user interface unit 120, to be described later, in addition to an output device. The display unit 110 may include at least one of a liquid crystal display, a thin film transistor-liquid crystal display, an organic light-emitting diode, a flexible display, and a 3D display. Among them, some displays may be constructed to be transparent so that the outside can be seen through the displays. These displays may be called transparent displays, and a representative example of the transparent displays may be a TOLED (Transparent Organic Light Emitting Diode). Also, two or more display units 110 may exist in accordance with the implementation forms of the display apparatus 100. For example, in the case of a mobile terminal, an external display unit (not illustrated) and an internal display unit (not illustrated) may be provided at the same time. Also, the touch screen may be configured to detect not only a touch input position and a touch input area but also a touch input pressure.

Also, the display unit 110 displays information that is processed in the display apparatus 100. For example, in a call mode in a state where the display apparatus 100 is implemented by a mobile terminal, a call-related UI (User Interface) or a GUI (Graphic User Interface) is displayed. Also, in the case where the display apparatus 100 is in a video call mode or in a photographing mode, a photographed and/or received image UI or GUI may be displayed.

The user interface unit 120 functions to receive and analyze a user command that is input from a user through an input device such as a mouse or a touch screen.

Specifically, the user interface unit 120 may receive various editing commands for various data objects. Here, the editing command may be a user command for performing an object merge, an object division, a clip board function, and the like. In this case, the object merge and the object division are performed in a thumbnail viewing state, and the clip board function may be performed during execution of the subject data object. For example, in the case where the subject data object is a moving image, the clip board function may be performed during reproduction of a moving image.

Also, the user interface unit 120 may receive various user commands to control the operation of the display apparatus 100, and may include a key pad, a dome switch, a touch pad (resistive/capacitive), a jog wheel, a jog switch, and the like. In particular, in the case where the touch pad forms a mutual layer structure together with the display unit 110 to be described later, this may be called a touch screen.

The editing unit 130 may perform an editing function of a data object in accordance with a user command received from the user interface unit 120. Here, the editing function may include at least one of a data object merge function, a data object division function, and a clip board function.

The control unit 140 functions to control the whole operation of the display apparatus 100.

Specifically, the control unit 140 may operate to enter into an editing mode if at least one icon is touched over a preset time in a normal mode.

Specifically, if a preset touch operation is performed with respect to an icon that corresponds to a data object in an editing mode, the control unit 140 may control the editing unit 130 to perform an editing function that corresponds to the preset touch operation with respect to the corresponding data object.

Here, if it is intended to select and merge two data objects, the preset touch operation that corresponds to the data object merge function may be an operation of simultaneously touching two data objects, narrowing a space between the two data objects, and then releasing the touch.

Also, if it is intended to select and merge at least three data objects, the preset touch operation that corresponds to the data object merge function may be an operation of touching a reference data object, successively selecting and dragging areas in which icons that correspond to remaining data objects to be merged are displayed to the reference data object, and then releasing the touch.

Also, if it is intended to divide at least one data object, the preset touch operation that corresponds to the data object division function may be an operation of selecting and touching at least two points of a data object, widening a space between the at least two selected points, and then releasing the touch. In this case, if the corresponding data object is a moving image, the control unit 140 may operate to convert an editing mode into a reproduction mode of the corresponding data object in order to separate moving image data.

Also, the control unit 140 may operate to create a clip board area of the data object in a predetermined area of a screen of the display unit 110 and to display the data object in the form of an icon on the created area in accordance with an editing command for performing the clip board function. Here, the clip board area may include at least one of a data copy area and a data deletion area.

Accordingly, a user can intuitively recognize whether data to be edited exists in the clip board area. For example, in the case where an icon form that corresponds to a predetermined data object is displayed in the copy area, the user can confirm that the corresponding data has been copied, while in the case where an icon form that corresponds to a predetermined data object is displayed in the deletion area, the user can confirm that the corresponding data has been deleted.

Also, the control unit 140 may operate to store or delete a data object by selecting and positioning the data object to be stored or deleted in the storage area or the deletion area of the data object on the screen in accordance with the editing command for performing the clip board function.

Also, the control unit 140 may operate to perform a paste function of the data object by touching and dragging the data object stored in the storage area of the data object to a desired position.

Also, the control unit 140 may operate to perform a partial cut function of the data object by selecting an area to be cut from at least one data object and dragging the selected area to the deletion area of the data object.

Also, a storage unit (not illustrated), which may store programs for processing and control through the control unit 140 and perform temporary storage of input/output data (for example, a phonebook, messages, still images, moving images, and the like), may be further included.

Specifically, the storage unit (not illustrated) may store data about vibration and sound of various patterns which are output when a touch is input on a touch screen. The storage unit (not illustrated) may include at least one type of storage media, such as flash memory type, hard disk type, multimedia card micro type, and card type memories (for example, an SD or XD memory, and the like), magnetic memories such as a RAM (Random Access Memory), an SRAM (Static Random Access Memory), a ROM (Read-Only Memory), an EEPROM (Electrically Erasable Programmable Read-Only Memory), and a PROM (Programmable Read-Only Memory), magnetic disks, and optical disks.

On the other hand, in the case where the display apparatus 100 is implemented by a mobile terminal, the display apparatus 100 may further include a radio communication unit (not illustrated) which includes one or more constituent elements that perform radio communication between the mobile terminal and a radio communication system or radio communication between the mobile terminal 100 and a network on which the mobile terminal 100 is positioned, an A/V (Audio/Video) input unit (not illustrated) to input an audio signal and/or a video signal, a sensing unit (not illustrated) to sense the current states of the mobile terminal 100, such as an open/close state of the mobile terminal 100, the position of the mobile terminal 100, existence/nonexistence of user contact, the direction of the mobile terminal, acceleration/deceleration of the mobile terminal, and the like, and to create sensing signals to control the operation of the mobile terminal 100, an interface unit (not illustrated) to server as an interface with all external appliances connected to the mobile terminal 100, an output unit (not illustrated) to output an audio signal, a video signal, or an alarm signal, and a power supply unit to receive an external power supply and an internal power supply and to provide the power supply that is required to operate the respective constituent elements.

Hereinafter, a method of providing a UI for an editing function of various data objects according to an exemplary embodiment of the present general inventive concept will be described in more detail.

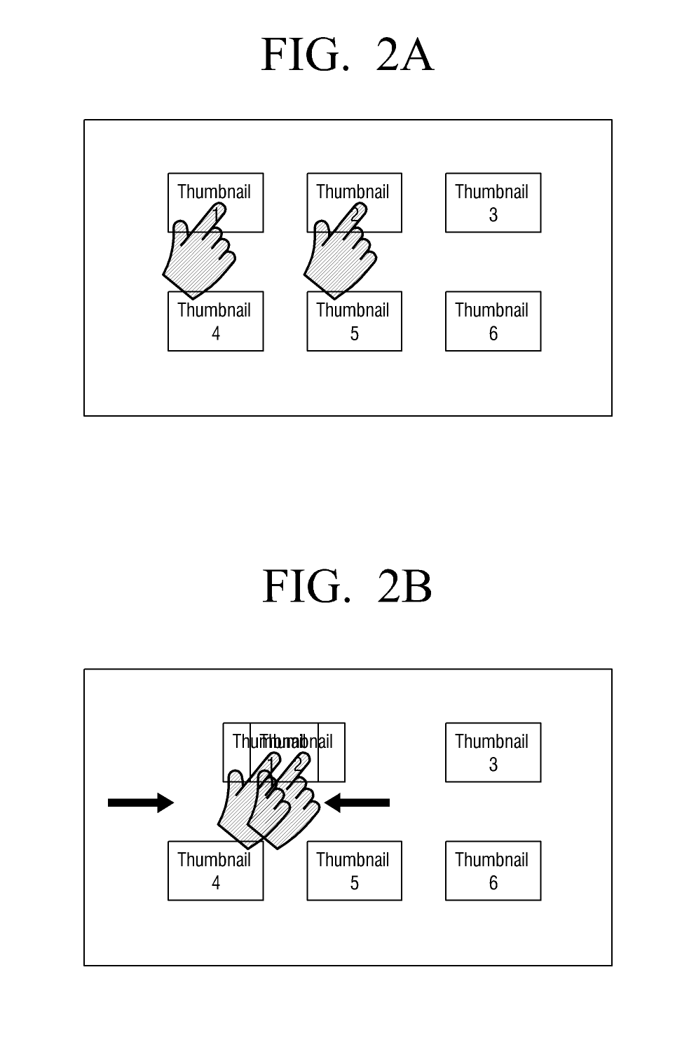

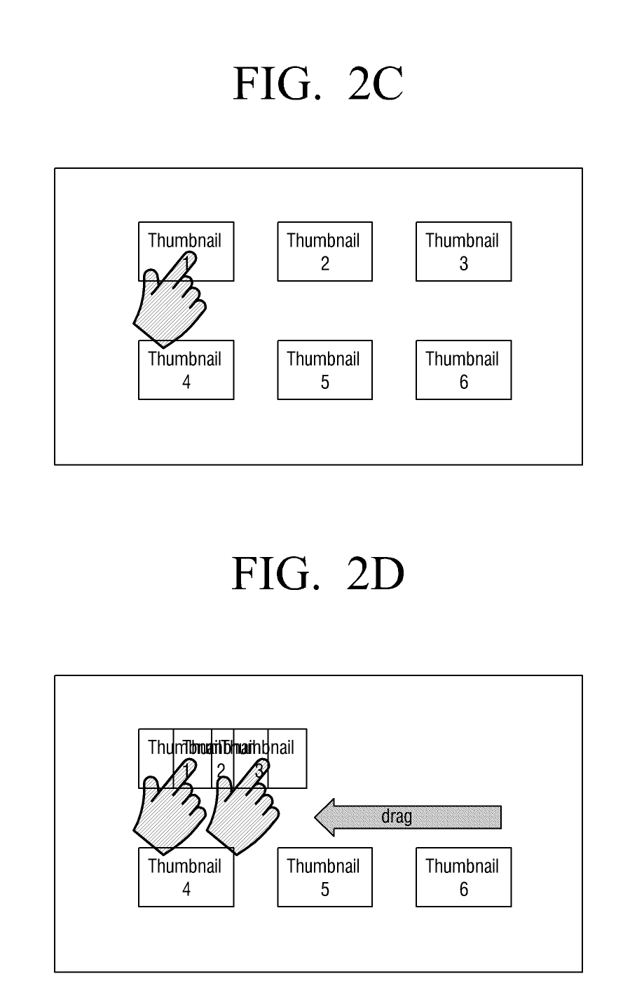

FIGS. 2A to 2D are diagrams illustrating a method of providing a UI for a data object merge function according to an exemplary embodiment of the present general inventive concept.

Although not illustrated in the drawing, a user may enter into an editing mode by touching at least one icon over a preset time. Here, the preset time may be a range of time that includes an error range.

As illustrated in FIG. 2A, if it is intended to merge two data objects that are displayed in the form of icons on the screen of the display unit 110 (or user interface unit 120), a user simultaneously touches the corresponding data objects for a predetermined time and maintains the touch without releasing the touch.

Then, as illustrated in FIG. 2B, if a user narrows a space between the two data objects by dragging the two data objects, and then releases the touch, the merge of the two data objects is executed.

The merge function is an operation of combining data objects into a single new data object. Here, when the merge is executed, the two data objects are combined into a new single data object including the contents of the two data objects. For example, if the two data objects are images, execution of the merge will result in a new data object containing both images.

Also, if the user widens the space between the two data objects in a state as illustrated in FIG. 2A again, the merge state is released. That is, if the user does not release the touch when the space between the two data objects is narrowed, as illustrated in FIG. 2B, but instead widens the space between the two data objects, as illustrated in FIG. 2A, and then releases the touch, the merge is not executed and the two data objects are not combined.

On the other hand, if it is intended to merge three or more data objects that are displayed in the form of icons on the display unit 110 as illustrated in FIG. 2C, the user makes a reference point by touching one data object over a predetermined time, and then maintains the touch without releasing the touch.

Then, if the user successively selects and drags other data objects to be merged to the reference point and then releases the touch as illustrated in FIG. 2D, the merge of the at least three data objects is executed.

Also, if the user returns the merged data objects to their original positions in the state as illustrated in FIG. 2C, the merge state of the data objects is released.

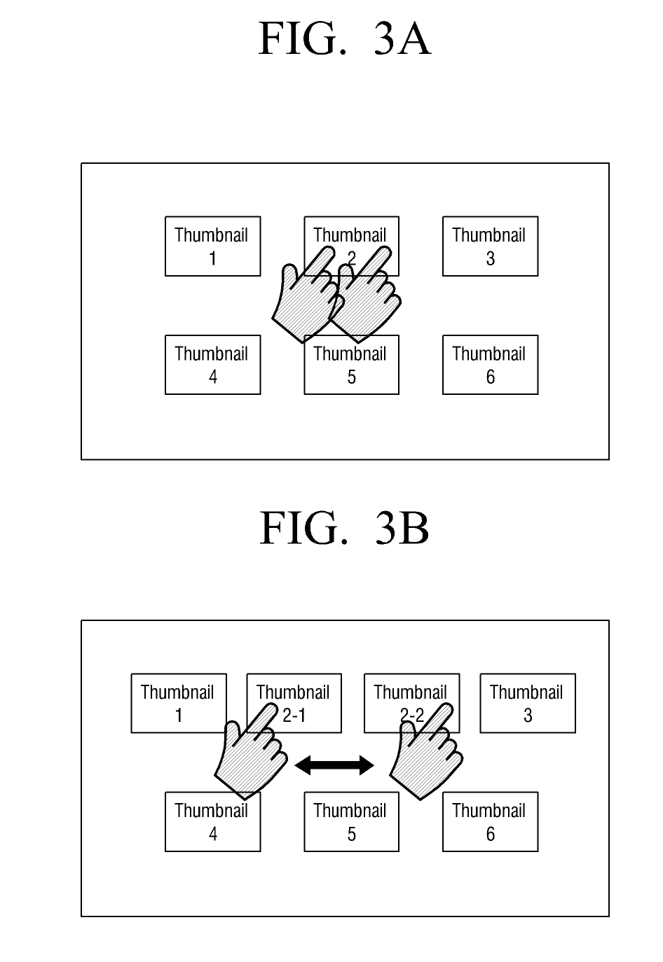

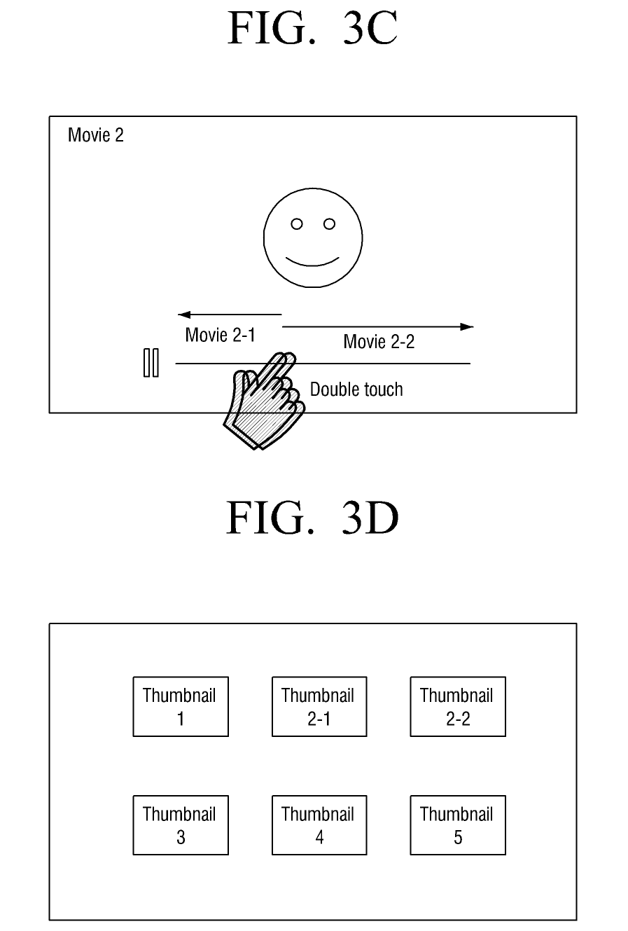

FIGS. 3A to 3D are diagrams illustrating a method of providing a UI for a data object division function according to an exemplary embodiment of the present general inventive concept.

As illustrated in FIG. 3A, the user touches two points of a data object to be divided and then maintains the touch state without releasing the touch.

Then, if the user widens the space between the two touch points in both directions as if the user tore the data object to two pieces, as illustrated in FIG. 3B, the corresponding icon is divided into two pieces to achieve the division of the data object. If the user narrows the space between the data objects in this state, the data object division function is released. That is, if the user releases the touch in the state illustrated in FIG. 3A, the data object division function is not executed.

The data object division function is an operation to divide the data object into two new data objects. When the data object division function is executed, the data object is divided into two new data objects, each of the new data objects include part of the contents of the original data object.

In the case where the data object is an image such as a moving image, if the user releases the touch in the state as illustrated in FIG. 3B, the corresponding moving image is converted into an image reproduction area as illustrated in FIG. 3C.

If the user performs double click (or double touch) of a desired point on the image being reproduced as illustrated in FIG. 3C, the corresponding point is divided into two pieces, and thus the mode is converted into a thumbnail viewing mode as illustrated in FIG. 3D to complete the creation of the divided data objects.

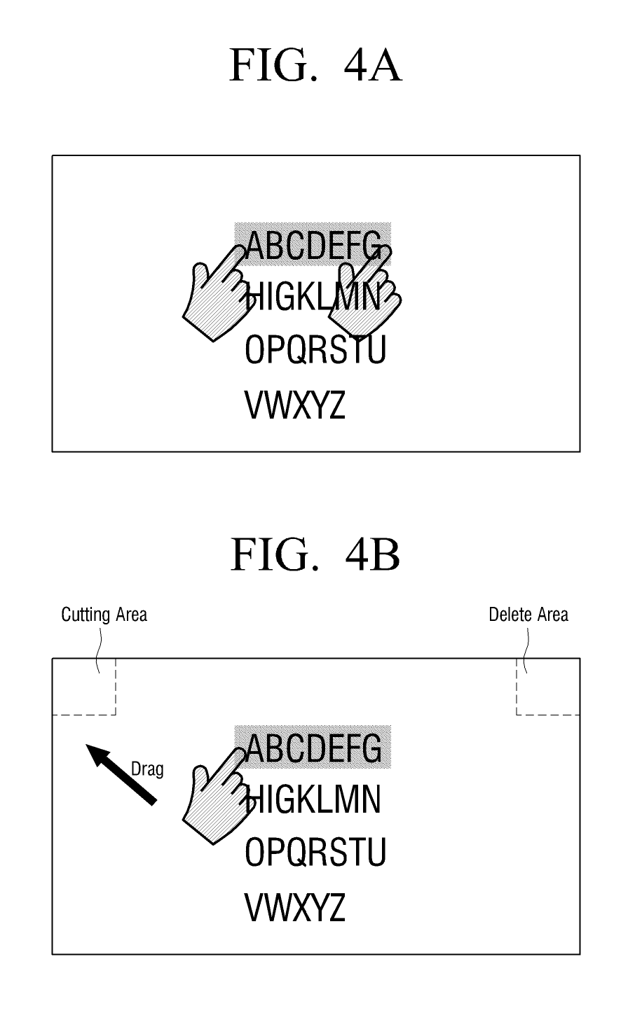

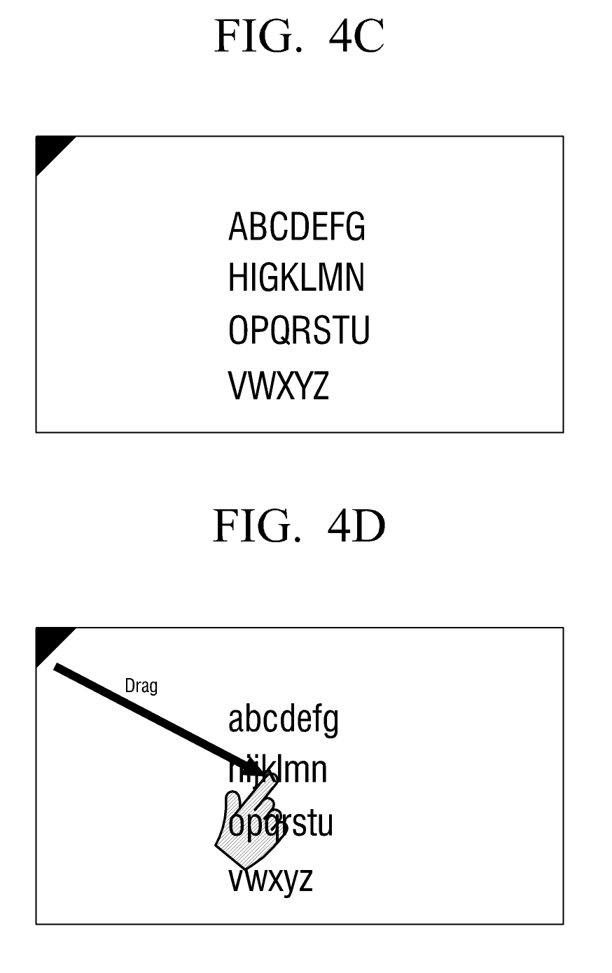

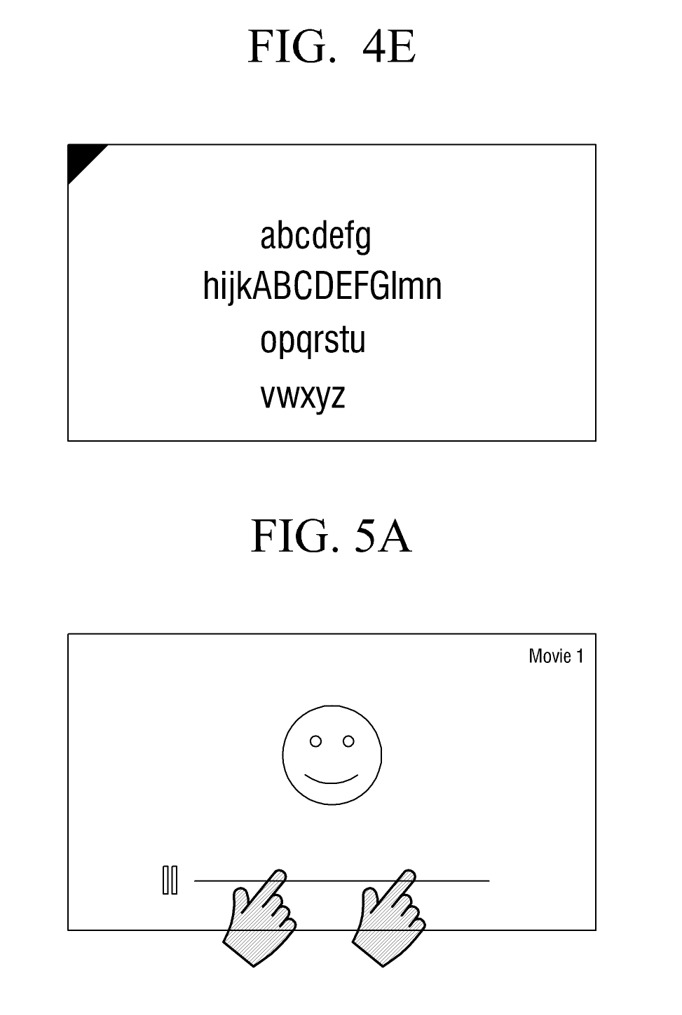

FIGS. 4A to 4E are diagrams illustrating a method of providing a UI for a data object clip board function according to an exemplary embodiment of the present general inventive concept.

Although the above-described object merge function (see FIGS. 2A to 2D) and object division function (see FIGS. 3A to 3D) are performed in the thumbnail viewing state, the clip board function is performed during the reproduction of the file in the case where the corresponding data object is a reproducible file such as a moving image.

As illustrated in FIG. 4A, the user selects two points of the data object desired to be copied. For example, as illustrated in FIG. 4A, the user touches a point slightly to the left of “A” and a point slightly to the right of “G” to select the text “ABCDEFG”.

Then, as illustrated in FIG. 4B, the user drags the two selected points to a predetermined area to move the selected data object to the predetermined area. As illustrated in FIG. 4B, the user drags the selected text “ABCDEFG” to an area in the upper left portion of the display defined as a cutting area. A selection which is dragged to the cutting area may be stored and retrieved later. The display may also include a predefined delete area. For example, in FIG. 4B, the delete area is defined as an upper right portion of the display. A selection which is dragged to the delete area may be deleted. Although the cutting area and the delete area are illustrated in the upper left and upper right corners of the display in FIG. 4B, the cutting area and delete area may be located at various positions on the display.

As illustrated in FIG. 4C, an icon is created in the upper left portion of the display to represent the selected data object which was dragged to the cutting area. Here, the selected data object is the text “ABCDEFG” which was dragged to the cutting area. As illustrated in FIG. 4C, the icon is a triangle and is displayed in the same portion of the display as the cutting area. However, the selected data object may be represented in other forms such as a thumbnail image, text, and the like or may be displayed in various locations within the display.

Then, as illustrated in FIG. 4D, the user may touch and drag the icon created at an upper end on the left side to the corresponding data object or another data object to insert the icon into a determined insertion position. For example, in FIG. 4D the text “abcdefghijklmnopqrstuvwxyz” is displayed and the user drags the icon to the point between “k” and “I”, and then releases the touch.

FIG. 4E illustrates the result of executing the data object insertion as shown in FIG. 4D. As illustrated in FIG. 4E the selected data object is inserted in the position where the user dragged the icon. Here, the text “ABCDEFG” was inserted between “k” and “l”, resulting in the display of “abcdefghijkABCDEFGlmnopqrstuvwxyz”. Additionally, the icon remains displayed in the upper left part of the display so that the user may insert the selected text into other parts of the displayed data object or into other data objects.

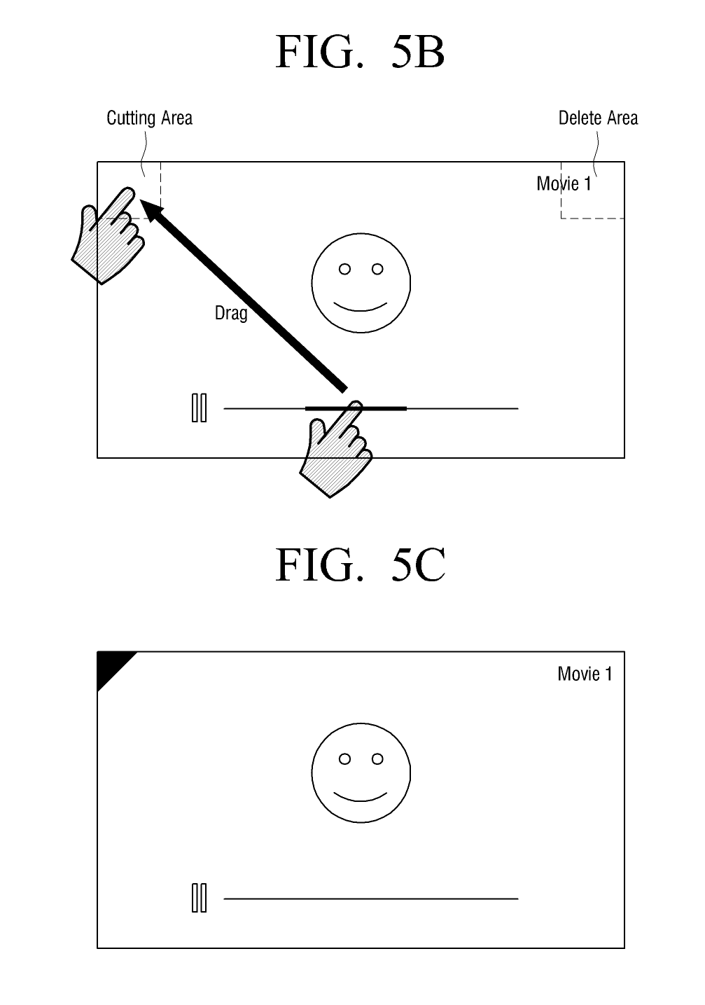

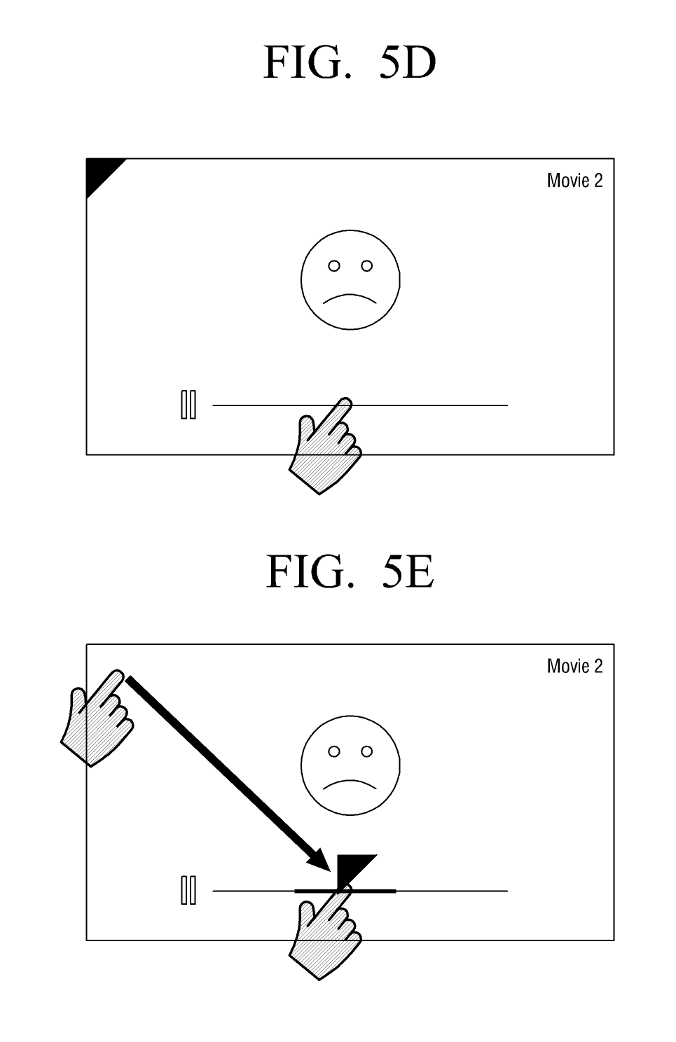

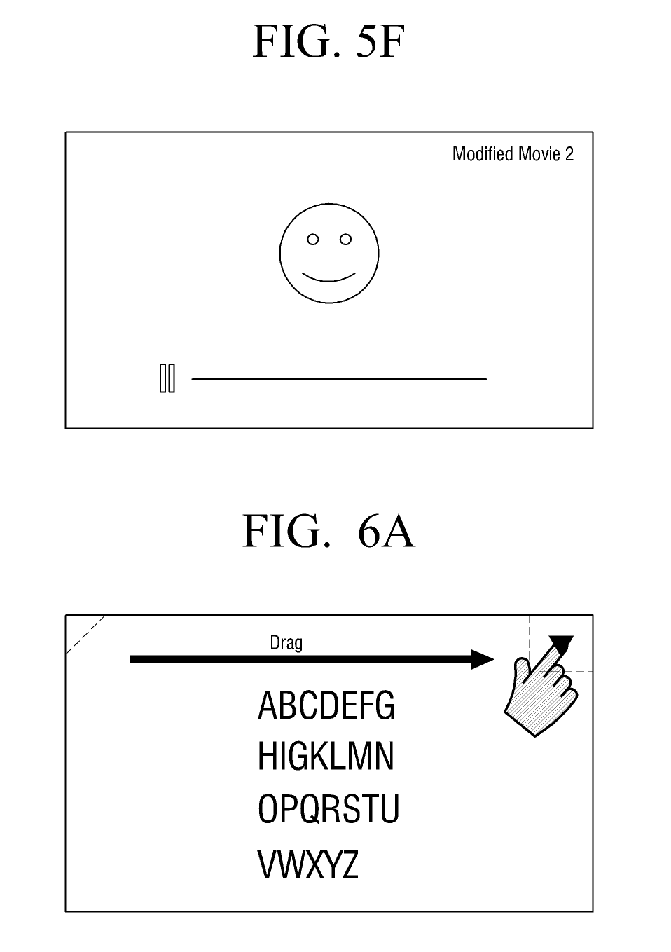

FIGS. 5A to 5F are diagrams illustrating a method of providing a UI for a data object clip board function according to another exemplary embodiment of the present general inventive concept.

With reference to FIGS. 5A to 5F, a case where the data object is a moving image will be described.

FIG. 5A is a display of a moving image. Here, the title of the moving image is displayed in an upper right portion of the display. As illustrated in FIG. 5A, the title of the moving image is “Movie 1”. The content of the moving image may be displayed in a central portion of the display and a control bar may be displayed in a lower portion of the display. A user may use the control bar to perform operations on the moving image such as play, pause, and stop. A user may also use the control bar to select a time within the length of the moving image. As illustrated in FIG. 5A, the user selects two desired points on the control bar to be edited during the reproduction of a moving image. For example, the two points represent a first time and a second time within the length of the moving image and the selected portion to be edited is the time between the first time and the second time.

Then, as illustrated in FIG. 5B, the user drags the two selected points to a predetermined area (for example, at an upper end on the left side) to move the selected points to the predetermined area. As illustrated in FIG. 5B, the user drags the selected portion of the moving image “Movie 1” to the cutting area defined as an upper left part of the display.

As illustrated in FIG. 5C, an icon is created in the upper left portion of the display to represent the selected portion of the moving image which was dragged to the cutting area. Here, the icon represents the selected portion of “Movie 1” which was dragged to the cutting area.

Thereafter, as illustrated in FIG. 5D, the position in which the selected and copied area as illustrated in FIG. 5A is to be inserted is designated on the reproduction area of the corresponding data object or another data object, and the icon created at the upper end on the left side is inserted in the designated insertion position by touching and dragging the icon as illustrated in FIG. 5E.

For example, in FIG. 5D a new moving image titled “Movie 2” is displayed. As illustrated in FIG. 5D, the user selects a position on the control bar, and the time within the moving image corresponding to the selected position is displayed in a central portion of the display. In FIG. 5E, the user drags the icon representing the selected portion of the moving image “Movie 1” to the selected position on the control bar to insert the selected portion of the moving image “Movie 1” at the selected position of the moving image “Movie 2”.

However, the designation of the insertion position as illustrated in FIG. 5D may be unnecessary according to circumstances, and it is also possible to position the selected data just in the position of the reproduction area, in which the data is to be inserted, to insert the data therein. For example, a user may choose not to select a position on the control bar as illustrated in FIG. 5D, and may instead drag the icon representing the selected portion of the moving image to a desired position on the control bar.

FIG. 5F illustrates the result of executing the data object insertion as shown in FIG. 5E. As illustrated in FIG. 5F, the selected portion of the moving image “Movie 1” has been inserted at the selected position of the moving image “Movie 2”.

On the other hand, in the above-described embodiment, it is exemplified that the cutting area is created in the area at the upper end on the left side of the display screen. However, this is merely exemplary, and the cutting area for the clip board function may be created in various positions of the display screen.

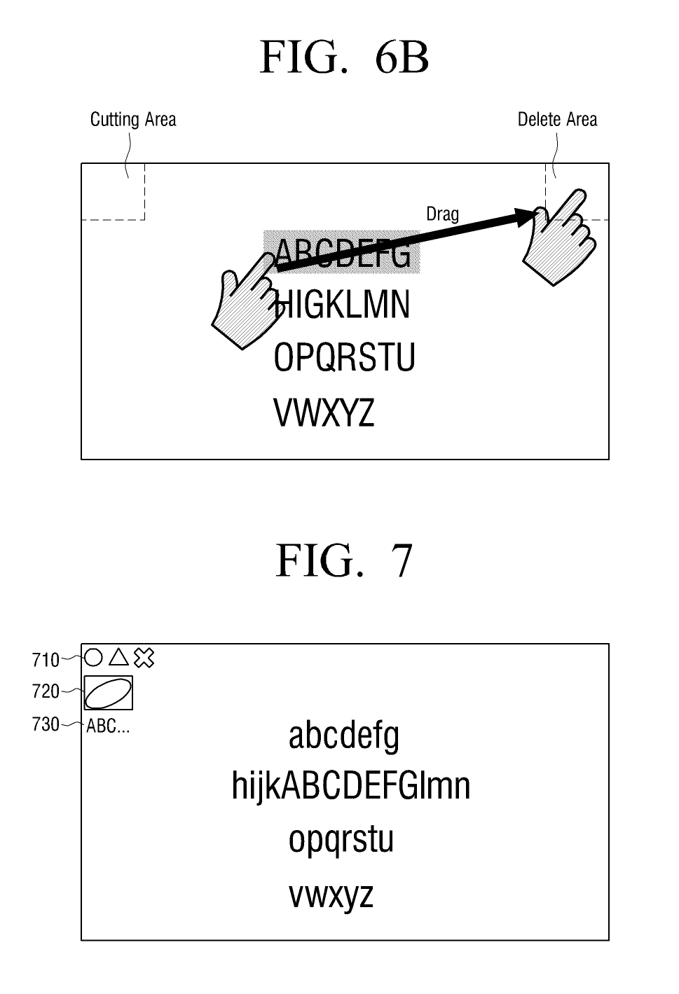

FIGS. 6A and 6B are diagrams illustrating a method of providing a UI for a data object clip board function according to still another exemplary embodiment of the present general inventive concept.

Referring to FIG. 6A, if it is intended to delete the data copied into the cutting area (at the upper end on the left side), the user may drag the corresponding icon in the cutting area to the deletion area (at the upper end on the right side) to delete the copied data. As illustrated in FIG. 6A, the user drags the triangle icon from the cutting area in the upper left part of the display to the deletion area in the upper right part of the display to delete any data that was previously copied to the cutting area.

Referring to FIG. 6B, the user may select a desired data area from the predetermined data object and drag the selected data area to the deletion area (at the upper end on the right side) to delete the corresponding data. For example, FIG. 6B illustrates that the text “ABCDEFG” is selected. The text may be selected by selecting a point slightly to the left of “A” and a point slightly to the right of “G”. As illustrated in FIG. 6B, the user drags the selected text “ABCDEFG” to the deletion area to delete the selected text.

FIG. 7 is a diagram illustrating a method of displaying an area for a clip board function according to an exemplary embodiment of the present general inventive concept. As illustrated in FIG. 7, icons 710, a thumbnail 720, and text data 730 are displayed in an upper left part of the display and indicate corresponding data objects.

As illustrated in FIG. 7, the clip board data stored in the storage unit may be displayed in the form of corresponding icons 710. As illustrated in FIG. 7, the corresponding icons 710 may include a circle, a triangle, and an “X” and may be located in an upper left part of the display. Different corresponding icons 710 may represent different data objects copied to the cutting area. For example, a first data object copied to the cutting area may be represented by a circle and a second data object copied to the cutting area may be represented by a triangle.

Also, the clip board data stored in the storage unit may be displayed in the form of a thumbnail 720 of the corresponding data object. As illustrated in FIG. 7, the thumbnail 720 may be located in an upper left part of the display.

Also, the clip board data stored in the storage unit may be displayed in the form of text data 730 that indicates the corresponding data object. As illustrated in FIG. 7, the text data 730 may be illustrated in an upper left part of the display.

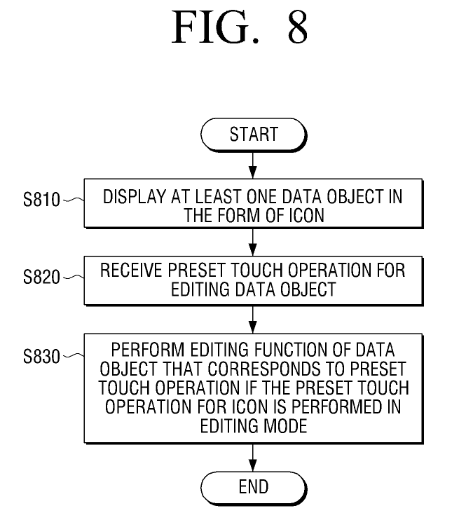

FIG. 8 is a flowchart illustrating a method of providing a UI according to an exemplary embodiment of the present general inventive concept.

Referring to FIG. 8, according to the method of providing a UI of a display apparatus according to an exemplary embodiment of the present general inventive concept, at least one data object is displayed in the form of an icon at operation S810.

Then, a preset touch operation for editing the data object is received at operation S820.

Thereafter, if the preset touch operation is performed with respect to the icon in an editing mode, an editing function of the data object that corresponds to the preset touch operation is performed (S830).

Also, if at least one icon is touched over a preset time in a normal mode, the mode may be shifted to an editing mode.

Here, the editing function may include at least one of a data object merge function, a data object division function, and a clip board function.

Also, if it is intended to select and merge two data objects, the preset touch operation that corresponds to the data object merge function may be an operation of simultaneously touching two data objects, narrowing a space between the two data objects, and then releasing the touch.

Also, if it is intended to select and merge at least three data objects, the preset touch operation that corresponds to the data object merge function may be an operation of touching a reference data object, successively selecting and dragging areas in which icons that correspond to remaining data objects to be merged are displayed to the reference data object, and then releasing the touch.

Also, if it is intended to divide at least one data object, the preset touch operation that corresponds to the data object division function may be an operation of selecting and touching at least two points of a data object, widening a space between the at least two selected points, and then releasing the touch.

Also, a clip board area of the data object may be created in a predetermined area of the display screen, and the data object may be displayed in the form of an icon on the created area in accordance with the preset touch operation to perform the clip board function.

Here, the clip board area may include at least one of a data copy area and a data deletion area, and the data object to be copied or deleted may be selected and dragged to the copy area or the deletion area to copy or delete the corresponding data object.

Also, the paste function of the data object may be performed by touching and dragging the data object copied into the copy area of the data object to a desired position.

Also, the partial cut function of the data object may be performed by selecting an area to be cut from at least one data object and dragging the selected area to the deletion area of the data object.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

The present general inventive concept may also be implemented using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro-controllers, microprocessors, and electric units to perform functions. In some cases, such exemplary embodiments may be implemented by the control unit.

According to software implementation, the exemplary embodiments such as procedures or functions may be implemented together with separate software modules that perform at least one function or operation. Software codes may be implemented by software applications written in appropriate program languages. Also, software codes may be stored in a memory and executed by the control unit.

As described above, according to the present general inventive concept, the data editing process is shortened, and thus an effective editing can be performed.

Specifically, the gestures of gathering files in the case of merging the files and tearing a file in the case of dividing the file are intuitive, and thus the user can easily and quickly learn the editing method.

Also, in the case of the clip board function, the cut files are created and maintained in the form of icons using an upper end corner portion that is not generally used on the screen, it is easy to confirm whether any cut file exists and to insert the cut file into another file without implementing a multi-window.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising:
a display unit to display a data object in the form of a corresponding icon;
a user interface unit to receive a preset touch operation corresponding to an editing function to edit the data object;
an editing unit to perform the editing function to edit the data object; and
a control unit to control the editing unit to perform the editing function to edit the data object that corresponds to the preset touch operation when the preset touch operation for the icon is performed in an editing mode.

2. The display apparatus as claimed in claim 1, wherein the editing function includes at least one of a data object merge function, a data object division function, and a clip board function.

3. The display apparatus as claimed in claim 2, wherein the preset touch operation that corresponds to the data object division function is an operation of selecting and touching at least two points of the data object, widening a space between the at least two selected points, and then releasing the touch if it is intended to divide the data object.

4. The display apparatus as claimed in claim 3, wherein the control unit operates to convert the editing mode into a reproduction mode to separate a moving image in accordance with the preset touch operation that corresponds to the data object division function in the case where the data object is a moving image.

5. The display apparatus as claimed in claim 2, wherein the display unit displays at least two data objects and the preset touch operation that corresponds to the data object merge function is an operation of simultaneously touching two data objects, narrowing a space between the two data objects, and then releasing the touch if it is intended to select and merge the two data objects.

6. The display apparatus as claimed in claim 2, wherein the display unit displays at least three data objects and the preset touch operation that corresponds to the data object merge function is an operation of touching a first data object, successively selecting and dragging areas in which icons that correspond to at least two other data objects to be merged are displayed to the first data object, and then releasing the touch of the first data object if it is intended to select and merge the at least three data objects.

7. The display apparatus as claimed in claim 3, wherein the control unit operates to create a clip board area of the data object in a predetermined area of a screen of the display unit and to display the data object in the form of an icon on the created area in accordance with the preset touch operation to perform the clip board function.

8. The display apparatus as claimed in claim 7, wherein the clip board area includes at least one of a copy area and a deletion area, and
the control unit operates to copy or delete the data object by selecting and dragging the data object to the copy area or the deletion area, respectively.

9. The display apparatus as claimed in claim 8, wherein the control unit operates to perform a paste function of the data object by touching and dragging the data object copied onto the copy area to a desired position.

10. The display apparatus as claimed in claim 8, wherein the control unit operates to perform a partial cut function of the data object by selecting an area to be cut from the data object and dragging the selected area to the deletion area.

11. A method of providing a UI of a display apparatus, the method comprising:
displaying a data object in the form of an icon;
receiving a preset touch operation corresponding to an editing function to edit the data object; and
performing the editing function that corresponds to the preset touch operation when the preset touch operation for the icon is performed in an editing mode.

12. The method of providing the UI as claimed in claim 11, wherein the editing function includes at least one of a data object merge function, a data object division function, and a clip board function.

13. The method of providing the UI as claimed in claim 12, wherein the preset touch operation that corresponds to the data object division function is an operation of selecting and touching at least two points of the data object, widening a space between the at least two selected points, and then releasing the touch if it is intended to divide the data object.

14. The method of providing the UI as claimed in claim 13, further comprising converting the editing mode into a reproduction mode to separate a moving image in accordance with the preset touch operation that corresponds to the data object division function in the case where the data object is a moving image.

15. The method of providing the UI as claimed in claim 12, wherein the displaying the data object comprises displaying at least three data objects and the preset touch operation that corresponds to the data object merge function is an operation of touching a first data object, successively selecting and dragging areas in which icons that correspond to at least two other data objects to be merged are displayed to the first data object, and then releasing the touch of the first data object if it is intended to select and merge the at least three data objects.

16. The method of providing the UI as claimed in claim 12, wherein the displaying the data object comprises displaying at least two data objects and the preset touch operation that corresponds to the data object merge function is an operation of simultaneously touching two data objects, narrowing a space between the two data objects, and then releasing the touch if it is intended to select and merge the two data objects.

17. The method of providing the UI as claimed in claim 13, further comprising creating a clip board area of the data object in a predetermined area of a screen of the display unit and displaying the data object in the form of an icon on the created area in accordance with the preset touch operation to perform the clip board function.

18. The method of providing the UI as claimed in claim 17, wherein the clip board area includes at least one of a copy area and a deletion area, and
the method of providing the UI further comprises copying or deleting the data object by selecting and dragging the data object to the copy area or the deletion area, respectively.

19. The method of providing the UI as claimed in claim 18, further comprising performing a paste function of the data object by touching and dragging the data object copied onto the copy area to a desired position.

20. The method of providing the UI as claimed in claim 18, further comprising performing a partial cut function of the data object by selecting an area to be cut from the data object and dragging the selected area to the deletion area.

21. A display apparatus comprising:
a display unit to display at least one data object in the form of a corresponding icon;
a user interface unit to receive a plurality of preset touch operations corresponding to respective editing functions to edit the data object, wherein at least one of the plurality of preset touch operations comprises touching at least two points on the display unit simultaneously;
a control unit to determine which one of the plurality of preset touch operations is received by the user interface unit; and
an editing unit to perform the respective editing function corresponding to the determined preset touch operation.

22. The display apparatus as claimed in claim 21, wherein the plurality of preset touch operations corresponding to respective editing functions comprises at least one of a preset touch operation corresponding to a data object merge function, a preset touch operation corresponding to a data object division function, and a preset touch operation corresponding to a copy function.

23. The display apparatus as claimed in claim 22, wherein the at least one data object comprises a first data object and a second data object and the preset touch operation corresponding to the data object merge function comprises touching the first data object and the second data object simultaneously, sliding the first data object and the second data object into each other, and then releasing the touches on the first data object and the second data object.

24. The display apparatus as claimed in claim 22, wherein the at least one data object comprises a plurality of data objects and the preset touch operation corresponding to the data object merge function comprises touching a first data object of the plurality of data objects, and while touching the first data object, successively touching, sliding into the first data object, and releasing the touch on each of the plurality of data objects to be merged with the first data object, and then releasing the touch on the first data object.

25. The display apparatus as claimed in claim 22, wherein the preset touch operation corresponding to the data object division function comprises simultaneously touching two points of one of the at least one data object, sliding the two touched points away from each other, and then releasing the touch.

26. The display apparatus as claimed in claim 22, wherein the display unit displays the data corresponding to one of the at least one data object and the preset touch operation corresponding to the copy function comprises simultaneously touching two points within the data and releasing the touches on the two points to select an area of the data, and then touching the selected area of the data, sliding the selected area of the data to a predetermined copy area, and releasing the touch on the selected area.

27. A method of providing a UI of a display apparatus, the method comprising:
displaying at least one data object in the form of a corresponding icon;
receiving one of a plurality of preset touch operations corresponding to respective editing functions to edit the data object, wherein at least one of the plurality of preset touch operations comprises touching at least two points on the display unit simultaneously;
determining which one of the plurality of preset touch operations is received; and
performing the respective editing function corresponding to the determined preset touch operation.

28. The method of providing the UI as claimed in claim 27, wherein the plurality of preset touch operations corresponding to respective editing functions comprises at least one of a preset touch operation corresponding to a data object merge function, a preset touch operation corresponding to a data object division function, and a preset touch operation corresponding to a copy function.

29. The method of providing the UI as claimed in claim 28, wherein the at least one data object comprises a first data object and a second data object and the preset touch operation corresponding to the data object merge function comprises touching the first data object and the second data object simultaneously, sliding the first data object and the second data object into each other, and then releasing the touches on the first data object and the second data object.

30. The method of providing the UI as claimed in claim 28, wherein the at least one data object comprises a plurality of data objects and the preset touch operation corresponding to the data object merge function comprises touching a first data object of the plurality of data objects, and while touching the first data object, successively touching, sliding into the first data object, and releasing the touch on each of the plurality of data objects to be merged with the first data object, and then releasing the touch on the first data object.

31. The method of providing the UI as claimed in claim 28, wherein the preset touch operation corresponding to the data object division function comprises simultaneously touching two points of one of the at least one data object, sliding the two touched points away from each other, and then releasing the touch.

32. The method of providing the UI as claimed in claim 28, wherein the displaying further comprises displaying the data corresponding to one of the at least one data object and the preset touch operation corresponding to the copy function comprises simultaneously touching two points within the data and releasing the touches on the two points to select an area of the data, and then touching the selected area of the data, sliding the selected area of the data to a predetermined copy area, and releasing the touch on the selected area.

33. A display apparatus comprising:
a display unit to display one or more data objects; and
a control unit to select one of the displayed data objects and to separate the selected data object into at least two data objects that each include a portion of the selected data object according to a first touch operation on the selected data object, and to select at least two of the displayed data objects and to merge the at least two selected data objects into one data object according to a second touch operation on the at least two selected data objects.
